(19) United States
(12) Patent Application Publication
(10) Pub. No.: US 2015/0197239 A1
(43) Pub. Date: Jul. 16, 2015

(54) MODULAR POWERTRAIN WITH MULTIPLE MOTORS

(71) Applicant: Deere & Company, Moline, IL (US)

(72) Inventors: Eric Vilar, Dubuque, IA (US); William Edward Reeves, Coffeyville, KS (US)

(21) Appl. No.: 14/334,303

(22) Filed: Jul. 17, 2014

Related U.S. Application Data
(60) Provisional application No. 61/927,129, filed on Jan. 14, 2014.

(51) Int. Cl. B60W 20/00; B60W 10/08; B60W 10/02

(52) U.S. Cl. CPC B60W 20/108; B60W 10/02; B60W 10/08; Y10S 903/93

(57) ABSTRACT

A vehicle may comprise an engine, a first electric machine connected to the engine, a multi-speed transmission engageable with the ground through a gearbox, a second electric machine electrically connected to the first electric machine and engageable with the ground through the multi-speed transmission, and a third electric machine electrically connected to the first electric machine and engageable with the ground through the gearbox and not through the multi-speed transmission.

### FIELD OF THE DISCLOSURE

The present disclosure generally relates to a vehicle powertrain.

### BACKGROUND

Vehicle powertrains may be comprised of electric machines, multi-speed transmissions, disconnect mechanisms, and gearboxes.

### SUMMARY

According to an aspect of the present disclosure, a vehicle may include an engine, a first electric machine, a multi-speed transmission, a second electric machine, and a third electric machine. The first electric machine may be connected to the engine. The multi-speed transmission may be engageable with the ground through a gearbox. The second electric machine may electrically connected to the first electric machine and may be engageable with the ground through the multi-speed transmission. The third electric machine may be electrically connected to the first electric machine and may be engageable with the ground through the gearbox but not through the multi-speed transmission.

According to another aspect of the present disclosure, the vehicle may also include a controller configured to command the second electric machine and the third electric machine based on a position of a user input.

According to another aspect of the present disclosure, the controller may also be configured to command the second electric machine and the third electric machine based on an efficiency of the second electric machine and an efficiency of the third electric machine.

According to another aspect of the present disclosure, a method of controlling a powertrain of a vehicle may include sensing an input indicative of at least one of a requested rimpull, requested acceleration, requested speed, and requested torque for the vehicle, sensing an input indicative of a speed of the vehicle, selecting a first available rimpull from a first electric machine engageable with the ground through a multi-speed transmission, selecting a second available rimpull from a second electric machine engageable with the ground at a fixed speed ratio, commanding the first electric machine to produce the first rimpull, and commanding the second electric machine to produce the second rimpull.

According to another aspect of the present disclosure, the method of controlling the powertrain of the vehicle may also include selecting at least one of the first rimpull and the second rimpull based on an efficiency with which at least one of the first electric machine can produce the first rimpull and the second electric machine can produce the second rimpull.

According to another aspect of the present disclosure, the method of controlling the powertrain of the vehicle may also include selecting the first rimpull and selecting the second rimpull such that, when combined, the first rimpull and the second rimpull are sufficient to achieve the requested rimpull, requested acceleration, requested speed, or requested torque.

According to another aspect of the present disclosure, the method of controlling the powertrain of the vehicle may also include selecting the first rimpull and selecting the second rimpull based on an efficiency with which the first electric machine can produce the first rimpull, an efficiency with which the second electric machine can produce the second rimpull, and the requested rimpull, requested acceleration, requested speed, or requested torque.

According to another aspect of the present disclosure, the method of controlling the powertrain of the vehicle may also include selecting the first rimpull and selecting the second rimpull based on the amount of vehicle power generated in excess of vehicle power consumed.

According to another aspect of the present disclosure, the method of controlling the powertrain of the vehicle may also include selecting the first rimpull and the second rimpull to achieve the requested rimpull, requested acceleration, requested speed, or requested torque while minimizing the rimpull from one of the first electric machine or the second electric machine.

According to another aspect of the present disclosure, the method of controlling the powertrain of the vehicle may also include selecting the first rimpull and the second rimpull based on a temperature of the first electric machine, the second electric machine, or the multi-speed transmission.

According to another aspect of the present disclosure, the method of controlling the powertrain of the vehicle may also include commanding a disconnect mechanism to open and disengage the multi-speed transmission from the ground when the first rimpull is zero.

According to another aspect of the present disclosure, the method of controlling the powertrain of the vehicle may also include selecting a non-zero value for the first rimpull, determining whether a disconnect mechanism through which the multi-speed transmission is engageable with the ground is disconnected, commanding the first electric machine to reduce the difference between an input speed of the disconnect mechanism and an output speed of the disconnect mechanism while the disconnect mechanism is determined to be disconnected, and commanding the disconnect mechanism to connect when the difference between the input speed of the disconnect mechanism and the output speed of the disconnect mechanism is below a threshold.

According to another aspect of the present disclosure, a vehicle may include a first electric machine and a second electric machine. The first electric machine may be engageable with the ground through a multi-speed transmission. The second electric machine may be engageable with the ground at a fixed speed ratio.

According to another aspect of the present disclosure, the vehicle may also include an engine and a third electric machine connected to the engine and electrically connected to the first electric machine and the second electric machine.

According to another aspect of the present disclosure, the vehicle may also include a controller configured to command the first electric machine and the second electric machine based on a position of a user input.

According to another aspect of the present disclosure, the controller may also be configured to command at least one of the first electric machine and the second electric machine based on an efficiency of at least one of the first electric machine and the second electric machine.

According to another aspect of the present disclosure, the vehicle may also include a controller configured to command at least one of the first electric machine and the second electric machine based on a temperature of at least one of the first electric machine, the second electric machine, and the multi-speed transmission.

According to another aspect of the present disclosure, the controller may also be configured to command at least one of the first electric machine and the second electric machine based on a thermal headroom of at least one of the first electric machine, the second electric machine, and the multi-speed transmission.

According to another aspect of the present disclosure, the vehicle may also include a controller configured to command at least one of the first electric machine and the second electric machine based on an available torque of at least one of the first electric machine and the second electric machine.

According to another aspect of the present disclosure, the multi-speed transmission may be engageable with the ground through a clutch and the controller may be configured to disconnect the clutch when the first electric machine is not exerting torque.

The above and other features will become apparent from the following description and accompanying drawings.

### BRIEF DESCRIPTION OF THE DRAWINGS

The detailed description of the drawings refers to the accompanying figures in which:

FIG. 1 is a left side elevation view of a wheel loader.

FIG. 2 is a left side elevation view of an articulated dump truck.

FIG. 3 is a schematic view of an example powertrain for a vehicle with four wheels.

FIG. 4 is a schematic view of an example powertrain for a vehicle with four wheels.

FIG. 5 is a schematic view of an example powertrain for a vehicle with six wheels.

FIG. 6 is a schematic view of an example powertrain for a vehicle with four wheels.

FIGS. 7a-7c are graphs generally illustrating the efficiency of an electric machine generating rimpull through a multi-speed transmission as a function of vehicle speed for three different speed ratios.

FIG. 8 is a graph generally illustrating the efficiency of an electric machine generating rimpull without a multi-speed transmission as a function of vehicle speed.

FIG. 9 is a flowchart illustrating an example method for controlling a powertrain for a vehicle.

### DETAILED DESCRIPTION

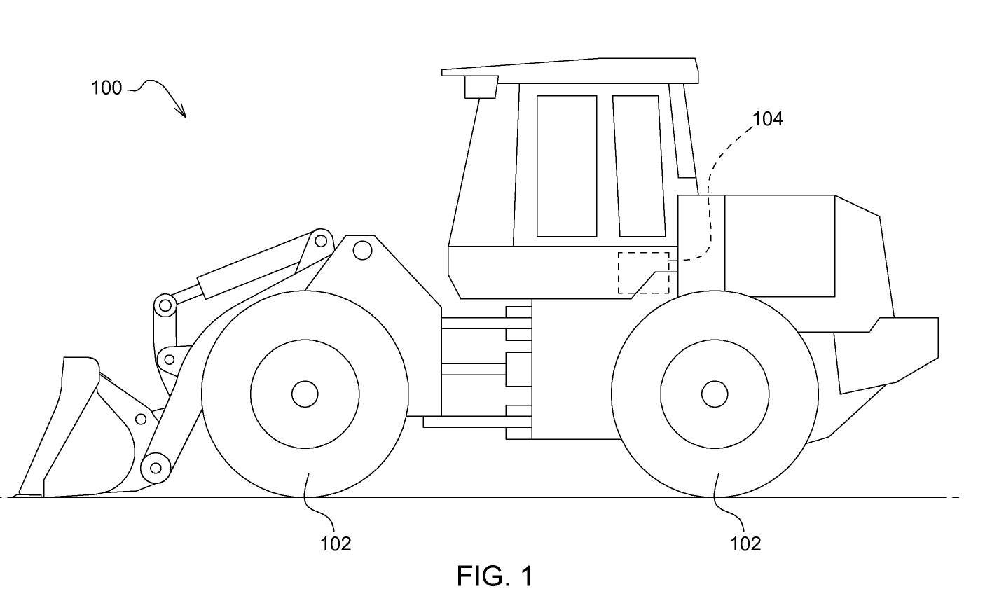

FIG. 1 illustrates vehicle 100, for example a wheel loader comprising four wheels 102 and controller 104.

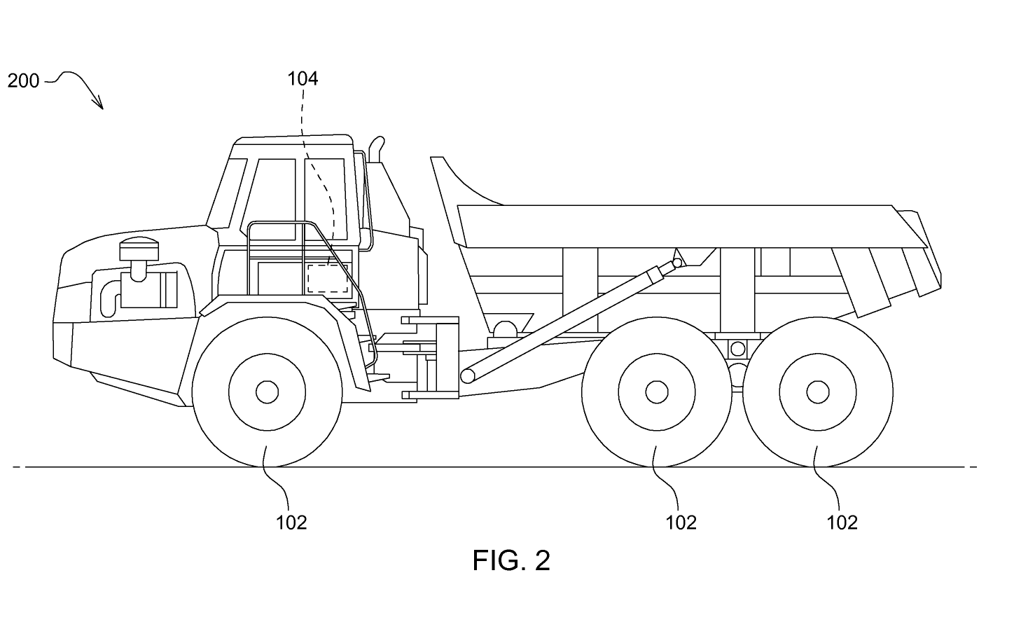

FIG. 2 illustrates vehicle 200, for example an articulated dump truck comprising six wheels 102 and controller 104.

The vehicle may be any vehicle with a powertrain and any number of wheels, tracks, or other ground engaging components, such as a construction or forestry vehicle. Vehicle 100 is illustrated as a wheel loader and vehicle 200 is illustrated as an articulated dump truck, but the vehicle may also be, to list just a few examples, a backhoe loader, crawler, excavator, feller buncher, forwarder, harvester, knuckleboom loader, motor grader, scraper, skidder, skid steer loader, track loader, or off-highway truck (such as a mining truck).

Controller 104 may control the powertrain of vehicle 100 or vehicle 200. Controller 104 is in communication with sensors, controllers, and operator inputs such that it may send electrical signals to, or receive electrical signals from, such other components. Controller 104 may communicate with the sensors, controllers, and operator inputs in a number of manners, including through radio transceivers, a wiring harness, or through a Controller Area Network (CAN), an electrical bus intended to transmit such communications. Controller 104 may sense operator inputs (e.g., switch positions, pedal positions), sense the state of vehicle components (e.g., engine speed, transmission gear, clutch engagement), determine component performance (e.g., engine power output, drivetrain power output), command components (e.g., command a torque output from an electric machine, shift the transmission to a different gear, disconnect clutches), and send messages to the operator, to name but a few operations which controller 104 may perform.

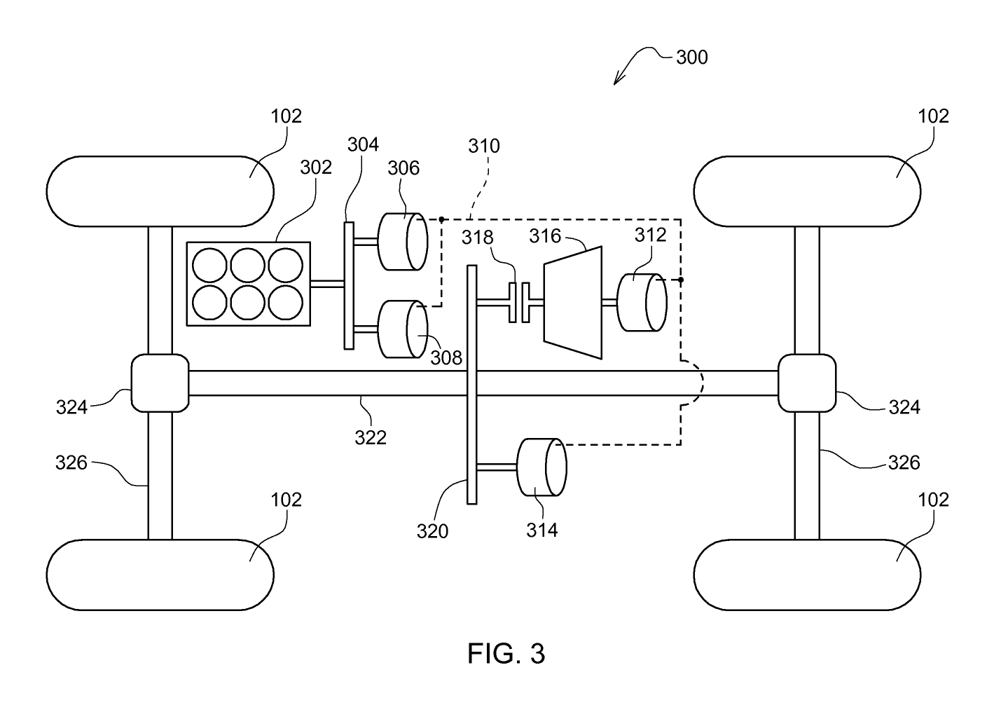

FIG. 3 illustrates powertrain 300, a powertrain embodiment which may power a vehicle with four wheels such as vehicle 100, comprising engine 302, engine gearbox 304, first generator 306, second generator 308, electrical bus 310, first motor 312, second motor 314, transmission 316, clutch 318, driveshaft gearbox 320, driveshaft 322, differentials 324, axles 326, and wheels 102.

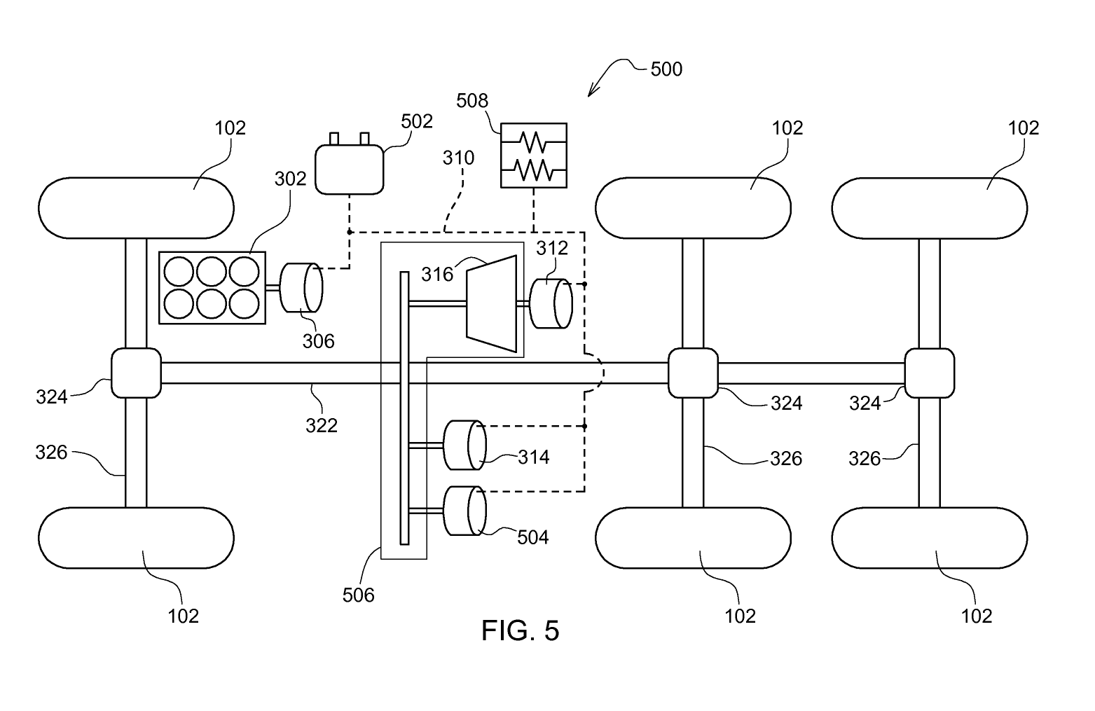

Engine 302, for example a diesel engine, connects to first generator 306 and second generator 308 through engine gearbox 304. As used herein, “connect,” and conjugations thereof, comprises connections through which mechanical power may be transmitted, including both direct connections and indirect connections which include intermediate components. As used herein, “electrically connect,” and conjugations thereof, comprises connections through which electrical power may be transmitted, including both direct connections and indirect connections which include intermediate components. First generator 306 electrically connects to electrical bus 310 and may generate electric power for, or draw electric power from, electrical bus 310. Second generator 308 also electrically connects to electrical bus 310 and may generate electrical power for, or draw electrical power from, electrical bus 310. First generator 306 and second generator 308 may be operated in tandem, for example each generating the same amount of electrical power, or they may be operated independently, for example first generator 306 generating electrical power while second generator 308 generates no power. Engine 302 may indirectly connect to engine gearbox 304 through other components, such as a flywheel, coupler, or shaft. Engine gearbox 304 may serve multiple functions. It may provide mounts to aid in connecting multiple components to engine 302, such as first generator 306, second generator 308, hydraulic pumps, and other components. Such mounts may be positioned to improve the overall packaging of powertrain 300. Engine gearbox 304 may also be designed so its mounts rotate faster or slower than engine 302, or rotate in the opposite direction. This may be desirable when the maximum speed of first generator 306 or second generator 308, for example 10,000 rotations per minute (RPM), is greater than the maximum speed of engine 302, for example 2,500 RPM. Alternatively, first generator 306 and second generator 308 may be directly connected to engine 302 (see FIG. 5).

The term gearbox, when used herein, refers to devices and methods known in the art for transferring, splitting, combining, or altering mechanical force, particularly torsional forces, including those that can create a speed ratio between an input and an output (e.g., the ratio of the rotational speed of an input to the rotational speed of an output). A gearbox is not limited to mechanical gears, and may include combinations of gear systems (e.g., bevel, crown, helical, hypoid, spur), hydraulic systems (e.g., pumps, motors), and continuously variable systems (e.g., variable diameter pulleys, toroids, cones), to name just a few known methods for transferring, splitting, combining, or altering mechanical force.

Although first generator 306 and second generator 308 are referred to as “generators” and first motor 312 and second motor 314 are referred to as “motors” for simplicity, each may be an electric machine capable of operating as a generator to convert mechanical energy into electrical energy and a motor to convert electrical energy into mechanical energy. For example, when vehicle 100 is accelerating, first generator 306 and second generator 308 may operate as generators to convert mechanical energy from engine 302 into electrical energy on electrical bus 310, and first motor 312 and second motor 314 may operate as motors to convert this electrical energy into mechanical energy to provide motoring rimpull (i.e., rimpull tending to propel the vehicle) to wheels 102. When vehicle 100 is decelerating, first motor 312 and second motor 314 may operate as generators to convert mechanical energy from wheels 102 into electrical energy on electrical bus 310, and first generator 306 and second generator 308 may operate as motors to convert this electrical energy into mechanical energy to rotate engine 302 or other components connected to it, and thereby provide retarding rimpull (i.e., rimpull tending to retard the vehicle), a technique which may be referred to as regenerative braking. As used herein, “rimpull” means the tractive force exerted by the vehicle on the ground, for example 1,200 N in sum exerted through wheels 102, and includes both motoring and retarding rimpull. First generator 306, second generator 308, first motor 312, and second motor 314 may each be any number of AC or DC electric machine types, for example induction, synchronous, shunt, permanent magnet, or switched reluctance, to name but a few types of electric machines.

First generator 306, second generator 308, first motor 312, and second motor 314 may be controlled, for example through power electronics, to suit the needs of the powertrain 300. Power electronics are not shown in FIGS. 1-7 for the simplification of illustration, it being understood that it would be well within the skill of one of ordinary skill in the art to provide these features without undue experimentation. First generator 306, second generator 308, first motor 312, and second motor 314 may be controlled to target, for example: speed of vehicle 100, rotational speed of engine 302, torque or power to or from engine 302, torque or power to or from an electric machine, rimpull or power of wheels 102, amperage or power to or from electrical bus 310, voltage on electrical bus 310, or some combination of these and other operational parameters.

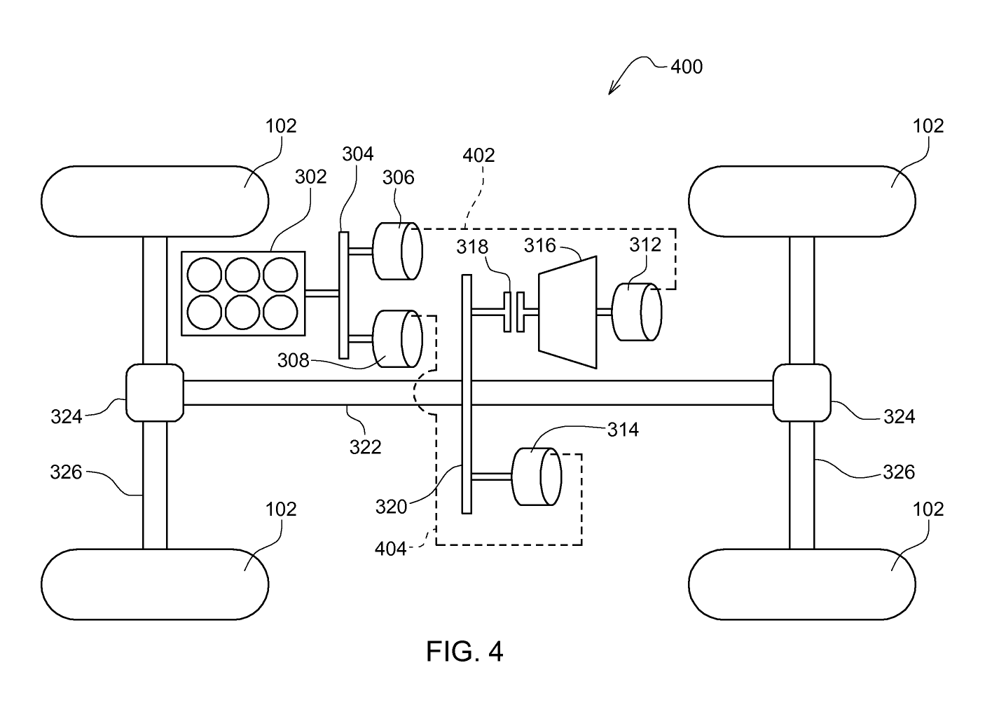

Electrical bus 310 transmits electrical power between first generator 306, second generator 308, first motor 312, and second motor 314. Electrical bus 310 thereby electrically connects first generator 306, second generator 308, first motor 312, and second motor 314, either directly, or indirectly through power electronics or other components controlling the electric machines or conditioning their electrical input and output. The design of electrical bus 310 depends on the type of electric machines used for powertrain 300, and may be comprised, for example, of two conductors for DC electric machines (some applications may use an electrical path through the vehicle chassis) or three conductors for three-phase electric machines. Alternatively, multiple electrical busses may be used to connect the generators and the motors, such as using a separate electrical bus for each generator-motor pair (see FIG. 4).

Driveshaft gearbox 320 is connected to driveshaft 322, clutch 318, and second motor 314. Driveshaft gearbox 320, like engine gearbox 304, may serve multiple functions. It may provide mounts to aid in connecting multiple components to driveshaft 322, such as clutch 318, second motor 314, hydraulic pumps, parking brakes, and other components. Such mounts may be positioned to improve the overall packaging of powertrain 300, such as to bridge a drop from where these components are located down to driveshaft 322 (sometimes referred to as a “dropbox” in such applications). Driveshaft gearbox 320 may also be designed to provide a speed ratio between its mounts and driveshaft 322. This may be desirable when the operating rotational speed ranges of transmission 316 and second motor 314 are different than that of driveshaft 322. Alternatively, clutch 318 and second motor 314 could be directly connected to driveshaft 322.

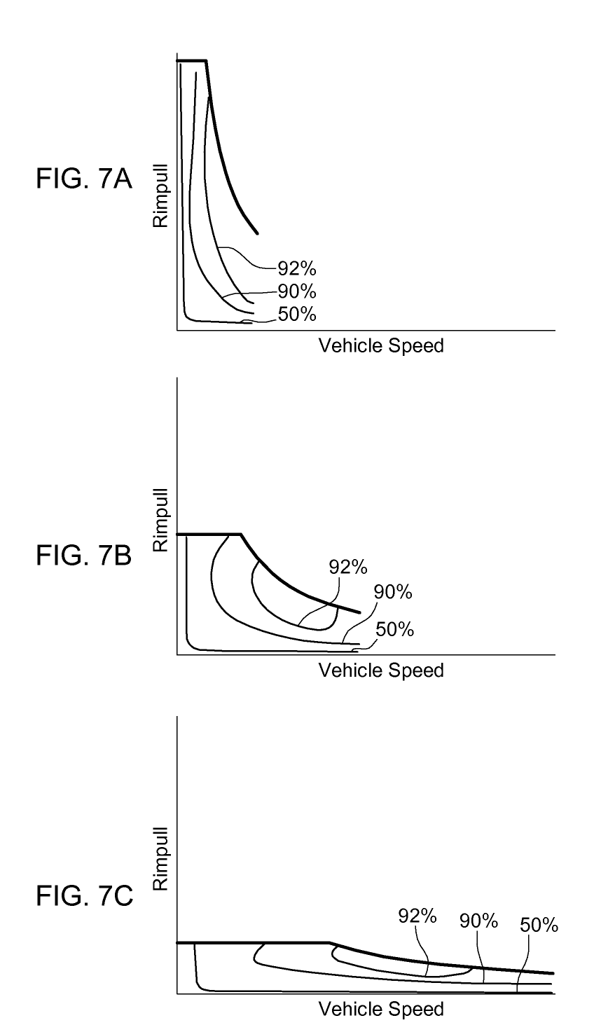

First motor 312 is connected to the input of transmission 316. The output of transmission 316 is connected to differentials 324, axles 326, and wheels 102 through disconnect mechanism clutch 318, driveshaft gearbox 320, and driveshaft 322. Transmission 316 selectively provides multiple speed ratios, such as three forward speed ratios in one embodiment (see FIGS. 7a-7c), and may also be known as a multi-speed transmission. Transmission 316 is connected to driveshaft gearbox 320 through clutch 318. Second motor 314 is directly connected to driveshaft gearbox 320. First motor 312 is connected to differentials 324, axles 326, and wheels 102 through transmission 316 (i.e., first motor 312 to transmission 316 to clutch 318 to driveshaft gearbox 320 to driveshaft 322 to differentials 324 to axles 326 to wheels 102), while second motor 314 is connected to differentials 324, axles 326, and wheels 102 not through transmission 316 (i.e., second motor 314 to driveshaft gearbox 320 to driveshaft 322 to differentials 324 to axles 326 to wheels 102). This configuration allows torque from second motor 314 to be transferred to wheels 102 substantially free of transmission 316, such that transmission 316 need not transfer such torque. This usage of two different paths for torque to reach wheels 102, one of which is not through transmission 316, allows for a more modular powertrain design as a range of rimpull characteristics may be achieved by changing the non-transmission motor (e.g., second motor 314 in FIG. 3) without changing the transmission. This configuration also allows first motor 312 and second motor 314 to rotate at different speeds, due to the speed ratio of transmission 316, even when both are exerting torque. As used herein, “exerting torque” includes torque both to and from an object or, alternatively, both positive and negative torque.

Driveshaft 322 may be connected, including selectively connected, to differentials 324. Differentials 324 may comprise any number of well-known differential types, including open, limited slip, and locking, and may comprise any number of features, including a disconnect mechanism allowing the differential to be selectively disconnected from driveshaft 322, it being understood that it would be well within the skill of one of ordinary skill in the art to utilize these differential types or provide these features without undue experimentation. Differentials 324 are connected to axles 326, on which are mounted wheels 102. Differentials 324 may also contain additional components, such as final drives, to achieve the desired total speed ratio between first motor 312 and second motor 314 and wheels 102.

Clutch 318 allows transmission 316 to be selectively connected to driveshaft gearbox 320. Clutch 318 may comprise any number of suitable clutch types, including friction, dog, and hydraulic, it being understood that it would be well within the skill of one of ordinary skill in the art to utilize these clutch types without undue experimentation. When clutch 318 is connected, transmission 316 is connected to driveshaft gearbox 320 and first motor 312 may thereby exert torque on wheels 102 and engage the ground at a total speed ratio determined at least in part by the speed ratio of transmission 316. When clutch 318 is disconnected, transmission 316 is not connected to driveshaft gearbox 320, is not engaged with the ground, and may instead rotate freely or cease rotational motion. Clutch 318 thereby allows transmission 316 and first motor 312 to be selectively disconnected from driveshaft 322 and wheels 102 and selectively engaged with the ground, which may be useful in multiple scenarios. Clutch 318 may be disconnected when the non-transmission motor(s) is able to provide sufficient motoring or retarding rimpull for vehicle 100, thereby allowing first motor 312 and transmission 316 to cease rotation. This may be useful to eliminate parasitic (sometimes referred to as “windage”) losses incurred by the rotation of transmission 316 and first motor 312, and may allow powertrain 300 to motor or retard vehicle 100 more efficiently than it could if both first motor 312 and second motor 314 were connected. In this disconnected state, first motor 312 and transmission 316 may also be used to store energy from electrical bus 310. First motor 312 can generate torque and increase the rotational speed of itself and transmission 316 and thereby store kinetic energy. To discharge such kinetic energy, motor 312 can retard the rotational speed of itself and transmission 316 and convert such kinetic energy into electrical energy on electrical bus 310. Clutch 318 may not be necessary if this disconnect feature is not desired (see FIG. 5).

Clutch 318 may be designed to accommodate rotational speed differences across itself when it connects. Alternatively, first motor 312 may be commanded to target a rotational speed that synchronizes the rotational speeds across clutch 318 to minimize the slippage and forces associated with closing clutch 318 while there is a rotational speed difference across it. This synchronization may allow for the usage of a less complex or more cost effective design for clutch 318 or extend the life of clutch 318. Perfect synchronization may not be required, and some embodiments may close clutch 318 as soon as the rotational speed difference across it is below a threshold, for example 100 RPM.

FIG. 4 illustrates powertrain 400 with an alternative electrical bus configuration to that of the embodiment in FIG. 3. In the embodiment in FIG. 3, electrical bus 310 transmits electrical power between first generator 306, second generator 308, first motor 312, and second motor 314. In the embodiment in FIG. 4, each generator-motor pair has its own electrical bus: first electrical bus 402 transmits electrical power between first generator 306 and first motor 312, and second electrical bus 404 transmits electrical power between second generator 308 and second motor 314. Electrically connecting all the generators and motors with a single electrical bus, as in FIG. 3, may provide advantages in certain applications by permitting one generator to power both motors, both generators to power one motor, one motor to power both generators, or both motors to power one generator. Using a separate electrical bus to electrically connect each generator-motor pair, as in FIG. 4, may provide advantages in certain applications by reducing the cost and complexity of ancillary components controlling generator, motor, and bus power (such as power electronics) or increasing the tolerance of a vehicle to the failure of an electrical bus or component connected to an electrical bus.

FIG. 5 illustrates powertrain 500, a powertrain embodiment which may power a vehicle with six wheels such as vehicle 200, comprising engine 302, first generator 306, battery 502, resistor grid 508, electrical bus 310, first motor 312, second motor 314, transmission 316, third motor 504, combination gearbox 506, driveshaft 322, differentials 324, axles 326, and wheels 102. This embodiment illustrates a number of alternative configurations to the embodiment illustrated in FIG. 3. Generators may be directly connected to engine 302, such as first generator 306, without using engine gearbox 304. Such a design may reduce weight, cost, and complexity if engine 302 is able to provide acceptable mounts for all the generators necessary for the powertrain. The optimal number of generators for the powertrain may vary depending on the application and the available generator designs, including one (see FIG. 5), two (see FIGS. 3-4), or more connected to engine 302 or engine gearbox 304. Battery 502 may be added to the powertrain to provide energy storage. Resistor grid 508 may be added to the powertrain to provide energy dissipation. Clutch 318 may be removed from the design if the disconnect feature and its associated advantages do not warrant the additional cost and complexity of adding such a clutch. Transmission 316 may be incorporated into combination gearbox 506, which may include inputs engaged with the ground through transmission 316 (e.g., the input connected to first motor 312) and inputs engaged with the ground not through transmission 316 (e.g., the inputs connected to second motor 314 and third motor 504). Alternatively, combination gearbox 506 could be mounted to one of axles 326 and incorporate one of differentials 324 and be used as a transaxle. The optimal number of motors for the powertrain may also vary depending on the application and the available motor designs, including with two (see FIGS. 3-4), three (see FIG. 5), or more connected to transmission 316, driveshaft gearbox 320, or directly to driveshaft 322.

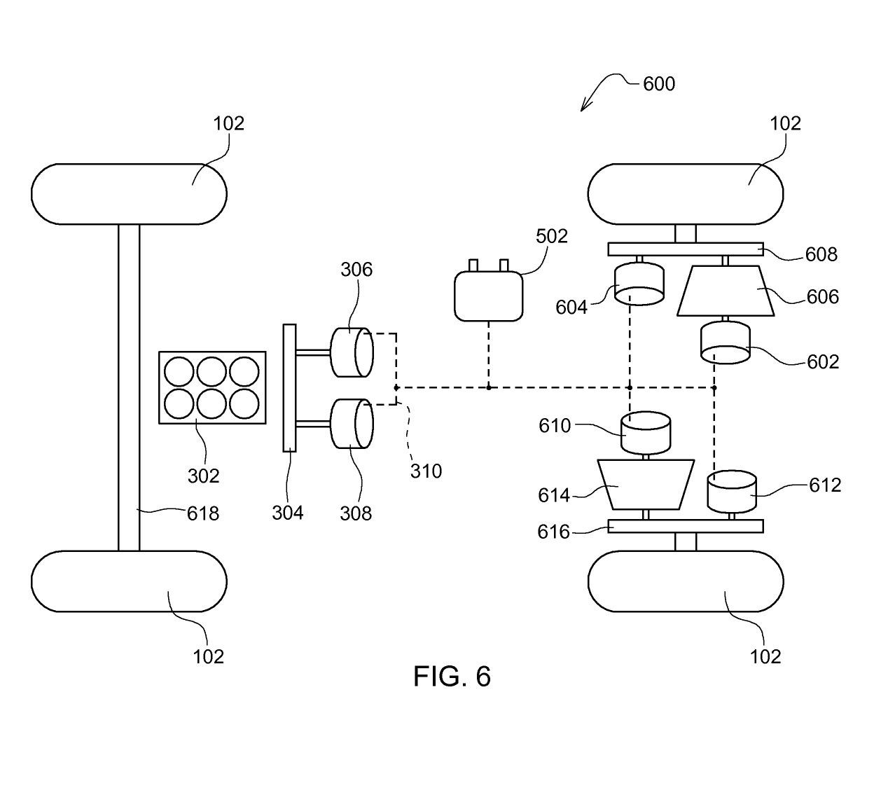

FIG. 6 illustrates powertrain 600, a powertrain embodiment which may power a vehicle with four wheels such as vehicle 100, comprising engine 302, engine gearbox 304, first generator 306, second generator 308, electrical bus 310, battery 502, right first motor 602, right second motor 604, right transmission 606, right final drive 608, left first motor 610, left second motor 612, left transmission 614, left final drive 616, axle 618, and wheels 102. Although a powertrain with four wheels and two powered wheels is illustrated in FIG. 6, alternative embodiments may have a different number of wheels and a different number of powered wheels.

Right first motor 602 is connected to right final drive 608 through right transmission 606. Right second motor 604 and right transmission 606 are directly connected to right final drive 608. Alternatively, right transmission 606 could connect to right final drive 608 through a disconnect mechanism, such as clutch 318 (see FIG. 4). Right final drive is connected to one of wheels 102 and provides an additional speed ratio to drive one of wheels 102. Similarly, left first motor 610 is connected to left final drive 608 through left transmission 614. Left second motor 612 and left transmission 614 are directly connected to left final drive 616. Alternatively, left transmission 614 could be connected to left final drive 616 through a disconnect mechanism, such as clutch 318 (see FIG. 4). Left final drive 616 is connected to one of wheels 102 and provides an additional speed ratio to drive one of wheels 102. In this embodiment, two of wheels 102 are unpowered, and axle 618 connects to these two wheels.

The electric machines connected to engine 302 (e.g., first generator 306 and second generator 308 in FIGS. 3-6) may alternatively be referred to as a first electric machine group, to reflect that the group may include one (e.g., see FIG. 5) or more (e.g., see FIGS. 3, 4, 6) electric machines acting as generators or motors depending on the powertrain design and application. The electric machines connected to wheels 102 through transmission 316 (e.g., first motor 312 in FIGS. 3-5, right first motor 602 and left first motor 610 in FIG. 6) may alternatively be referred to as a second electric machine group, to reflect that the group may include one or more electric machines acting as generators or motors. The electric machines connected to wheels 102 not through transmission 316 (e.g., second motor 314 and third motor 504 in FIGS. 3-5, right second motor 604 and left second motor 612 in FIG. 6) may alternatively be referred to as a third electric machine group, to reflect that the group may include one or more electric machines acting as generators or motors.

In the embodiment illustrated in FIG. 5, electrical bus 310 transmits power between first generator 306, battery 502, first motor 312, second motor 314, and third motor 504. Battery 502 is illustrated as directly connected to electrical bus 310, but, as with the electric machines in powertrains 300, 400, 500, and 600, power electronics are not shown but may be used to control electrical power to and from battery 502. Such power electronics may be electrically connected between battery 502 and electrical bus 310. Battery 502 is schematically represented as a chemical battery, but any suitable energy storage device may be used, including multiple chemical batteries, capacitors, flywheels, or hydraulic accumulators, to name but a few possible energy storage devices. Adding battery 502 to the powertrain may provide advantages such as reducing the peak power required from engine 302, reducing the variance of the voltage on electrical bus 310, allowing for the storage of energy from an external source (e.g., charging from the power grid), and storing energy when regenerative braking power exceeds total vehicle power consumption. Resistor grid 508 is schematically represented as a grid of resistors, but any energy dissipation device may be used. Adding resistor grid 508 to the powertrain may permit energy dissipation when regenerative braking power exceeds total vehicle power consumption.

Other alternative embodiments exist but are not depicted in FIGS. 1-6. For example, a fuel cell and associated power electronics may be used instead of engine 302, engine gearbox 304, first generator 306, and second generator 308 to generate power for electrical bus 310. Alternatively, battery 502 could be suitably sized and included in powertrains 300, 400, 500, and 600 to allow operation for a sufficient period of time without engine 302, a fuel cell, or any other power source. As an example, vehicle 100 or vehicle 200 could charge battery 502 from the power grid and use such stored power for a period of time before returning to the power grid to recharge. Differentials 324 may entail a design which locks or allows for limited slip between the left and right wheels 102 on each axle 326, but it is also possible to include differentials between axles 326 to permit axles 326 to rotate a different speeds and to provide inter-axle differential lock or limited slip to mitigate power loss when one axle slips.

Controller 104 may receive signals from, and send signals to, components in FIGS. 1-6 and associated sensors and controllers, including engine 302, first generator 306, second generator 308, electrical bus 310, first electrical bus 402, second electrical bus 404, first motor 312, second motor 314, third motor 504, right first motor 602, right second motor 604, left first motor 610, left second motor 612, transmission 316, right transmission 606, left transmission 614, clutch 318, and any power electronics, controllers, or sensors for any of these components.

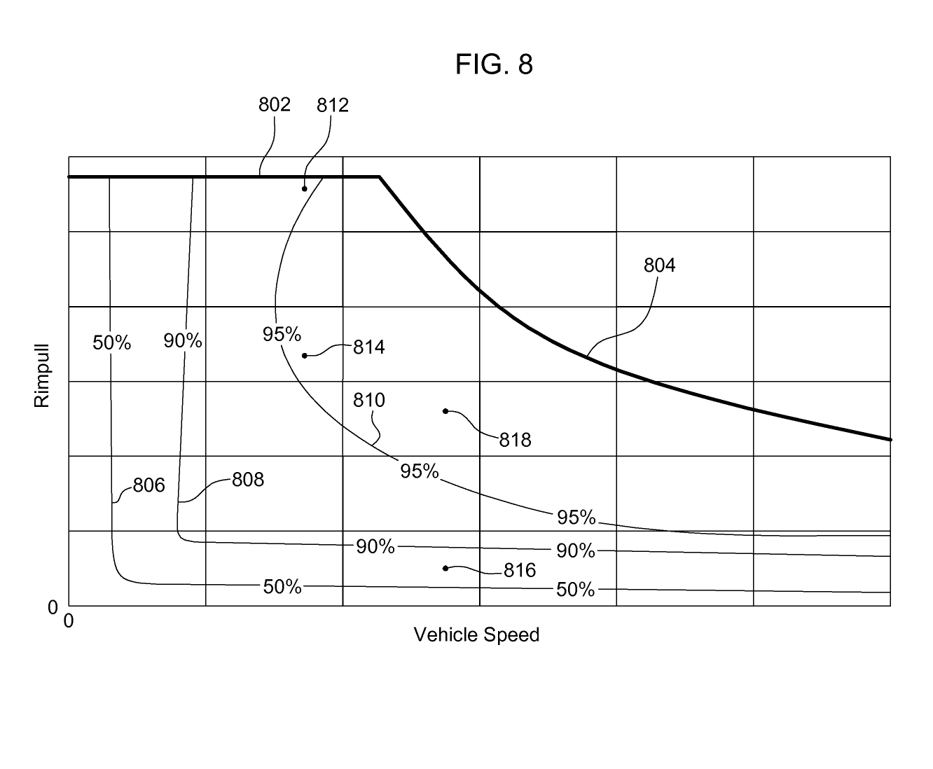

FIGS. 7a-7c generally illustrate the net efficiency of a motor engaged with the ground through a multi-speed transmission (including the losses associated with the transmission), such as first motor 312 in FIG. 3, as a function of motoring rimpull and vehicle speed. In this embodiment, transmission 316 has three forward speeds utilizing different speed ratios, and thereby achieving different net efficiencies for first motor 312. FIG. 7a generally illustrates such efficiency when transmission 316 is in the first forward speed. FIG. 7b generally illustrates such efficiency when transmission 316 is in the second forward speed. FIG. 7c generally illustrates such efficiency when transmission 316 is in the third forward speed. In FIGS. 7-8, net efficiency is illustrated as a function of rimpull and vehicle speed, but could alternatively be illustrated in a number of different formats, for example as a function of rimpull and motor speed, torque and vehicle speed, or torque and motor speed.

FIG. 8 generally illustrates the efficiency of a motor or motors engaged with the ground not through a multi-speed transmission, such as second motor 314 in FIGS. 3-4 or second motor 314 and third motor 502 in FIG. 5, as a function of rimpull and vehicle speed. In this example, the motor(s) have a constant-torque speed range 802 in which the motor is capable of delivering the same amount of torque (and corresponding rimpull) regardless of vehicle speed, and a constant-power speed range 804 in which the motor is capable of delivering the same amount of power regardless of vehicle speed. Constant efficiency lines 806, 808, and 810 generally illustrate the efficiency of the motor(s) at various vehicle speed and rimpull combinations. For a given vehicle speed, there is a range of rimpull available from the motor(s) and the efficiency of the powertrain may be optimized at that speed by commanding the amount of rimpull which achieves the desired efficiency. For example, decreasing the torque requested from a motor when the motor is operating at point 812 until it is operating at point 814 increases the motor's efficiency. As another example, increasing the torque requested from a motor operating at point 816 until it is operating at point 818 increases that motor's efficiency. The relationship between rimpull, efficiency, and vehicle speed may vary considerably depending on a number of factors, including the motor, power electronics, and total speed ratio in use.

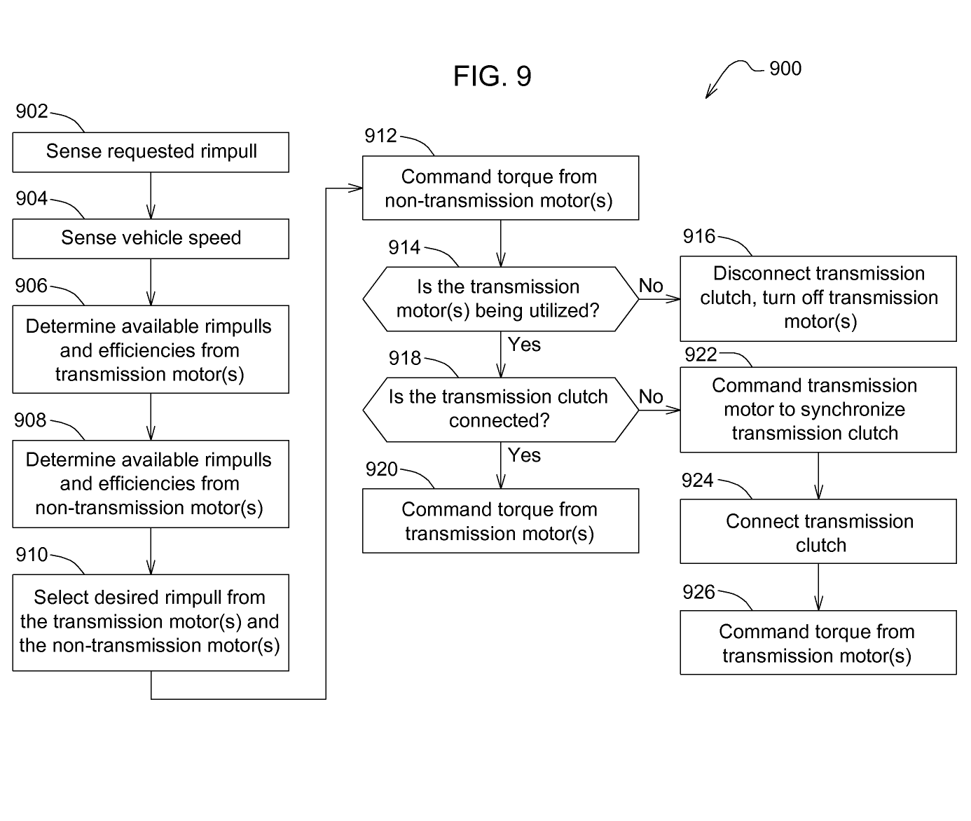

FIG. 9 illustrates control system 900, which controller 104 may be configured to execute, comprising steps 902, 904, 906, 908, 910, 912, 914, 916, 918, 920, 922, 924, and 926. In step 902, controller 104 senses the rimpull requested of the powertrain, such as by sensing the position of a user input (e.g., pedal, lever, dial, button) which the operator may actuate or by receiving a signal indicative of a requested rimpull from another sensor, controller, or control system. For example, a separate control system being executed on controller 104 may target a particular vehicle speed and send a signal indicative of requested rimpull (e.g., +500 N, −200 N, 65% of maximum rimpull, −15% of maximum rimpull) to control system 900 in step 902 to achieve that speed. Alternatively, in step 902, controller 104 may sense the torque requested of the powertrain, and convert that to a rimpull request based on the geometry of wheels 102 and other drivetrain geometry and speed ratios. Alternatively, in step 902, controller 104 may sense the acceleration or speed requested of vehicle 100 and calculate the rimpull required of the powertrain based on the requested acceleration or speed. The requested rimpull, speed, or acceleration may each be categorized as a vehicle propel command. In step 904, controller 104 senses the speed of the vehicle, such as by ground detecting radar, GPS, or sensors on wheels 102, axles 326, driveshaft 322, driveshaft gearbox 320, second motor 314, or any other component rotating at a known ratio to wheels 102 (including, for example, first motor 312 and second motor 314), or any other method known in the art.

Using the requested rimpull from step 902 and the vehicle speed from step 904, controller 104 determines the available rimpull and efficiency from the transmission motor(s) in step 906. The transmission motor(s) are those motors engaged with the ground through a multi-speed transmission, such as first motor 312 in FIG. 3. For example, the output from step 906 may include 100 N at 88% efficiency and 200 N at 90% efficiency. Step 906 requires knowledge of the correlation between rimpull, vehicle speed, and efficiency for the transmission motor(s), which could be achieved, for example, by storing information such as that generally represented in FIGS. 7a-7c in memory accessible by controller 104. Using the requested rimpull from step 902 and the vehicle speed from step 904, controller 104 determines the available rimpull and efficiency from the non-transmission motor(s) in step 908. The non-transmission motor(s) are those motors engaged with the ground not through a multi-speed transmission, such as second motor 314 and third motor 504, and thus are subject to a fixed speed ratio. Although the term “fixed speed ratio” is used, the speed ratio between, for example, second motor 314 and an individual wheel 102 may vary due to the effect of a differential 324, but the speed ratio will not be altered by a multi-speed transmission. For example, the output from step 908 may be 200 N at 93% efficiency and 400 N at 94% efficiency. Step 908 requires knowledge of the correlation between rimpull, vehicle speed, and efficiency for the non-transmission motor(s), which could be achieved, for example, by storing information such as that generally represented in FIG. 8 in memory accessible by controller 104.

In step 910, controller 104 selects the desired rimpull from the transmission motor(s) and the desired rimpull from the non-transmission motor(s). The method by which the amount of desired rimpull from each set of motor(s) is selected may vary depending on the embodiment and the current operating conditions for that embodiment. When motoring the vehicle, the available rimpulls and efficiencies from steps 906 and 908 may be used to select the combination of rimpulls which achieves the maximum overall powertrain efficiency or a target powertrain efficiency while producing the requested rimpull sensed in step 902. Some embodiments may include a feature to increase rimpull from the non-transmission motor(s) at the time the transmission undertakes a shift to mitigate or eliminate any overall powertrain rimpull reduction associated with the transmission shift. Some embodiments may include a feature to produce less than the requested rimpull sensed in step 902 if it allows increased powertrain efficiency, which may be referred to as an eco-mode or economy mode. When retarding the vehicle, the combination of rimpulls with the lowest overall powertrain efficiency or a target powertrain efficiency (below the maximum efficiency) may be selected to minimize the energy which must be dissipated from electrical bus 310, such as through resistor grid 508, while producing the requested rimpull sensed in step 902. Alternatively, in step 910, controller 104 may select the maximum available rimpull from the motor(s) which engage the ground through more durable (or lower wear-cost, or more serviceable) components and select additional rimpull from the motor(s) which engage the ground through the less durable (or higher wear-cost, or less serviceable) components only if necessary to reach the requested rimpull sensed in step 902. Alternatively, in step 910, controller 104 may distribute rimpull between the two sets of motor(s) based on the thermal headroom available (i.e., how close a component through which the motor(s) engages the ground is to exceeding a desired temperature range), to keep the temperatures of drivetrain components within a desired range. Further, step 910 could include a function to actuate the service brakes (e.g., friction brake pads and discs located in axles 326) if the retarding rimpull is requested and there is no thermal headroom available, in order to achieve blended braking (i.e., a blend of service braking and regenerative braking) equal to the requested rimpull sensed in step 902.

Step 910 may also involve combinations of the above, such as selecting the desired rimpull from each set of motor(s) to maximize overall powertrain efficiency when motoring, selecting the desired rimpull from each set of motor(s) to minimize energy dissipation when retarding, increasing rimpull from the non-transmission motor(s) when the transmission is shifting to mitigate overall rimpull reduction, and modifying these rimpulls as necessary to keep the temperatures of drivetrain components, including the motors, multi-speed transmission, and other components, within a desired range. Control system 900 may be designed to function regardless of the direction of the rimpull requested, and may therefore be designed to optimize the powertrain when providing both motoring rimpull and retarding rimpull.

For example, when controlling powertrain 300 using control system 900 to achieve maximum overall powertrain efficiency, if the rimpull request sensed in step 902 can be produced entirely by second motor 314 at 95% efficiency or can be produced entirely by first motor 312 through transmission 316 at 85% efficiency in the second forward gear and 91% efficiency in the third forward gear, step 910 would result in all the rimpull being produced by second motor 314 and none of the rimpull being produced by first motor 312. As another example, if the rimpull request sensed in step 902 can be produced in part by second motor 314 at 80% efficiency, or can be produced entirely by first motor 312 through transmission 316 at 90% efficiency in the first forward gear, step 910 would result in all the rimpull being produced by first motor 312. As yet another example, if half the rimpull request sensed from step 902 can be produced by second motor 314 at 94% efficiency, all the rimpull can be produced by first motor 312 through transmission 316 in first forward gear at 87% efficiency, or half the rimpull can be produced by first motor 312 through transmission 316 in second forward gear at 91% efficiency, step 910 would result in half the rimpull being produced by second motor 314 and half the rimpull being produced by first motor 312 through transmission 316 in second forward gear.

After the desired rimpulls are selected in step 910, controller 104 in step 912 commands the non-transmission motor(s) (e.g., second motor 314, third motor 504, right second motor 604, left second motor 612) to exert the necessary torque to achieve the rimpull selected for the non-transmission motor(s) in step 910. The requested rimpull of the non-transmission motor(s) may be converted to the torque necessary from the non-transmission motor(s) by a number of methods well known in the art, including lookup tables or the usage of a common percent (e.g., requesting 50% of maximum rimpull converts to 50% of maximum motor torque). If the powertrain lacks clutch 318 or an equivalent disconnect between transmission 316 and wheels 102, controller 104 would perform step 920 next and would command the transmission motor(s) (e.g., first motor 312, first right motor 602, first left motor 610) to exert the torque necessary to achieve the rimpull selected for the transmission motor(s) in step 910. The requested rimpull of the transmission motor(s) may be converted to the torque necessary from the transmission motor(s) by a number of methods well known in the art, including lookup tables or the usage of a common percent (e.g., requesting 50% of maximum rimpull requires 50% of maximum motor torque). FIG. 9 illustrates a control system for an embodiment including clutch 318, and therefore includes additional steps 914, 916, 918, 922, 924, and 926. In step 914, controller 104 determines whether the transmission motor(s) will produce rimpull based on the desired rimpull selected in step 910. If not, controller 104 disconnects clutch 318 (or keeps clutch 318 disconnected if it already was) and turns off or keeps off the transmission motor(s) in step 916. If the transmission motor(s) is producing rimpull per the desired rimpull selection from step 910, then controller 104 determines whether the transmission clutch (e.g., clutch 318) is already connected in step 918. If it is, then controller 104 commands the transmission motor(s) to the rimpull selected for it in step 910. If the transmission clutch is not connected, then controller 104 commands the transmission motor(s) to the speed which will synchronize the two sides of the transmission clutch. Once this synchronization is achieved, controller 104 commands the transmission clutch to engage and thereby connects the transmission with wheels 102 in step 924. Once the clutch is connected, controller 104 in step 926 commands the transmission motor(s) to exert the torque necessary to achieve the rimpull selected for the transmission motor(s) in step 910. The requested rimpull of the transmission motor(s) may be converted to the necessary torque from the transmission motor(s) by a number of methods well known in the art, including lookup tables or the usage of a common percent (e.g., requesting 50% of maximum rimpull converts to 50% of maximum motor torque).

Control system 900 synchronizes the two sides of the transmission clutch to minimize the forces it must accommodate when it goes from disconnected to connected, which may allow the usage of a smaller, lower cost, less complex clutch, or may extend the service life of the clutch chosen. Alternatively, step 922 could be eliminated if such a feature is not desired and the transmission clutch is capable of accommodating a significant difference in rotational speeds when it connects.

Although control system 900 is illustrated as a flowchart, the disclosure is not limited to such steps and the order of steps of presented, and it would be well within the skill of one of ordinary skill in the art to reorder, combine, or split many of the steps and achieve the same result.

While “rimpull” is used in this disclosure to characterize the ultimate tractive force output of each of the motors in the embodiments described herein, alternative embodiments may use alternate measure or measures. For example, control system 900 may instead utilize requested torque in step 902, available torques in steps 906 and 908, and select desired torques in step 910, which may involve less conversion between rimpull and torque for some embodiments.

As shown in embodiments powertrain 300, powertrain 400, powertrain 500, and powertrain 600, regenerative braking is possible and first motor 312, second motor 314, third motor 504, right first motor 602, right second motor 604, left first motor 610, and left second motor 612 may transmit energy onto electrical bus 310, first electrical bus 402, or second electrical bus 404. This energy may be used by first generator 306 or second generator 308 to transmit mechanical energy into engine 302 or other components connected to engine 302, such as hydraulic pumps, air conditioning compressors, fans, water pumps, and alternators. Further, battery 502 may be included in the powertrain to store energy on electrical bus 310. If the power generated by regenerative braking exceeds the total power consumption of the vehicle and the power which can be stored by battery 502, energy dissipation components such as resistor grid 508 may be installed (see FIG. 5). Control system 900 may be used to reduce the need for energy dissipation components when regenerative braking is used. More specifically, when control system 900 detects surplus power from regenerative braking beyond the vehicle's capacity to use or store the power, controller 104 in step 910 may select the desired rimpulls which reduce the powertrain efficiency, possibly enough to eliminate any surplus power. This would allow the dissipation of some excess regenerative braking power in certain drivetrain components (e.g., transmission 316, first motor 312, second motor 314, and third motor 504) rather than requiring that all excess regenerative braking power be dissipated by the energy dissipation components (e.g., resistor grid 508). This may allow the energy dissipation components to be downsized, extend the life of such components, or, in particular applications, allow the elimination of such components entirely. Including this “minimum surplus power” feature in control system 900 may be desirable in applications where the vehicle often encounters steep or long descents, particularly if the vehicle encounters such descents with a full payload.

Although wheels 102 mounted on axles 326 are shown in the embodiments illustrated in FIGS. 3-6, alternative embodiments may utilize other components to engage the vehicle with the ground, such as tracks. For example, FIG. 6 illustrates right first motor 602 engaged with the ground through right transmission 606, right final drive 608, and wheel 102. Alternatively, a track could replace wheel 102 in this configuration and right first motor 602 would still be engaged with the ground. As another example, FIG. 4 illustrates second motor 314 engaged with the ground through driveshaft gearbox 320, driveshaft 322, differentials 324, axles 326, and wheels 102, and first motor 312 engageable with the ground through transmission 316, clutch 318, driveshaft gearbox 320, driveshaft 322, differentials 324, axles 326, and wheels 102. In the embodiment illustrated in FIG. 4, first motor 312 is engageable with the ground as it may be engaged with the ground when clutch 318 is connected and disengaged from the ground when clutch 318 is disconnected. As used herein, “engaged with the ground,” and conjugations thereof, comprises configurations which allow the exertion of tractive force on the ground on which the vehicle rides, such as exerting tractive force on the ground through wheels or tracks.

Increasing the maximum rimpull and power which a powertrain is capable of transmitting to the ground on which a vehicle rides may require redesigning the transmission to handle increased torque and power. The design of a new transmission, even if it is a redesign of an existing product, may entail considerable cost, time, and risk, and a number of such new transmissions may be necessary if a number of different sized vehicles are desired. To reduce the number of transmission designs required, it may be possible to use oversized transmissions for some vehicle sizes, but such a course of action may increase the cost and weight of the vehicles using the oversized transmissions.

The powertrains and associated methods disclosed herein may broaden the range of vehicle sizes covered by, for example, transmission 316 by making the powertrains more modular through the usage of additional motors engaged with the ground not through transmission 316. Transmission 316 may satisfy a range of power and torque requirements by its use, for example, without second motor 314, with a small second motor 314, with a large second motor 314, or with second motor 314 and third motor 504. The number and size of the generators in powertrains 300, 400, 500, and 600 may need to be adjusted to provide sufficient electrical power for the motor configuration selected.

The powertrains and associated methods disclosed herein may also broaden the range of vehicle sizes which may be powered by a limited number of motor designs. First motor 312 and second motor 314 could be directly connected to driveshaft gearbox 320 or driveshaft 322 without transmission 316 or clutch 318. Such a configuration requires the motors to be sized so as to provide the peak torque required by the powertrain at all speeds, which may result in large motors which are expensive, difficult to manufacture, and inefficient for the torque and speed ranges the motors will encounter in non-peak torque conditions. The addition of transmission 316 allows first motor 312 to be connected to driveshaft 322 at multiple speed ratios (see FIGS. 7a-7c), permitting first motor 312 and second motor 314 to be sized significantly smaller while still meeting the peak rimpull requirements of the powertrain with the additional rimpull of first motor 312 engaged with the ground through transmission 316.

The powertrains and associated methods disclosed herein may also increase the efficiency of vehicle 100 and vehicle 200. The powertrain configurations each contain at least two paths for torque to reach wheels 102, one of which travels through a multi-speed transmission (e.g., transmission 316) and one which does not. Each path may contain multiple motors (e.g., second motor 314 and third motor 504 in FIG. 5). By including two paths with different performance characteristics, the rimpull split between the motors within the paths can be dynamically modified to improve the overall efficiency of the powertrain while still providing the requested rimpull. This improvement may be increased further by the addition of a clutch which can disconnect transmission 316 from the powertrain and stop its rotation to eliminate the windage and associated power loss when rimpull is not required from the transmission motor(s). Such a mode may be appropriate when the vehicle is traveling at relatively high speeds on flat terrain, as the non-transmission motor may be able to provide all the necessary rimpull for such an operation at a high efficiency.

As used herein, “based on” means “based at least in part on” and does not mean “based solely on,” such that it neither excludes nor requires additional factors.

While the disclosure has been illustrated and described in detail in the drawings and foregoing description, such illustration and description is not restrictive in character, it being understood that illustrative embodiment(s) have been shown and described and that all changes and modifications that come within the spirit of the disclosure are desired to be protected. Alternative embodiments of the present disclosure may not include all of the features described yet still benefit from at least some of the advantages of such features. Those of ordinary skill in the art may devise their own implementations that incorporate one or more of the features of the present disclosure and fall within the spirit and scope of the appended claims.

What is claimed is:

1. A vehicle comprising:
an engine;
a first electric machine connected to the engine;
a multi-speed transmission engageable with the ground through a gearbox;
a second electric machine electrically connected to the first electric machine and engageable with the ground through the multi-speed transmission;
a third electric machine electrically connected to the first electric machine and engageable with the ground through the gearbox and not through the multi-speed transmission.

2. The vehicle of claim 1, further comprising a controller, wherein the controller is configured to command the second electric machine and the third electric machine based on a position of a user input.

3. The vehicle of claim 2, wherein the controller is configured to command the second electric machine and the third electric machine based on an efficiency of the second electric machine and an efficiency of the third electric machine.

4. A method of controlling a powertrain of a vehicle comprising:
sensing an input indicative of at least one of a requested rimpull, requested acceleration, requested speed, and requested torque for the vehicle;
sensing an input indicative of a speed of the vehicle;
selecting a first available rimpull from a first electric machine engageable with the ground through a multi-speed transmission;
selecting a second available rimpull from a second electric machine engageable with the ground at a fixed speed ratio;
commanding the first electric machine to produce the first rimpull; and
commanding the second electric machine to produce the second rimpull.

5. The method of claim 4, further comprising selecting at least one of the first rimpull and the second rimpull based on an efficiency with which at least one of the first electric machine can produce the first rimpull and the second electric machine can produce the second rimpull.

6. The method of claim 4, further comprising selecting the first rimpull and selecting the second rimpull such that, when combined, the first rimpull and the second rimpull are sufficient to achieve the requested rimpull, requested acceleration, requested speed, or requested torque.

7. The method of claim 4, further comprising selecting the first rimpull and selecting the second rimpull based on an efficiency with which the first electric machine can produce the first rimpull, an efficiency with which the second electric machine can produce the second rimpull, and the requested rimpull, requested acceleration, requested speed, or requested torque.

8. The method of claim 4, further comprising selecting the first rimpull and selecting the second rimpull based on the amount of vehicle power generated in excess of vehicle power consumed.

9. The method of claim 4, further comprising selecting the first rimpull and the second rimpull to achieve the requested rimpull, requested acceleration, requested speed, or requested torque while minimizing the rimpull from one of the first electric machine or the second electric machine.

10. The method of claim 4, further comprising selecting the first rimpull and the second rimpull based on a temperature of the first electric machine, the second electric machine, or the multi-speed transmission.

11. The method of claim 4, further comprising commanding a disconnect mechanism to open and disengage the multi-speed transmission from the ground when the first rimpull is zero.

12. The method of claim 4, further comprising:
selecting a non-zero value for the first rimpull;
determining whether a disconnect mechanism through which the multi-speed transmission is engageable with the ground is disconnected;
commanding the first electric machine to reduce the difference between an input speed of the disconnect mechanism and an output speed of the disconnect mechanism while the disconnect mechanism is determined to be disconnected; and
commanding the disconnect mechanism to connect when the difference between the input speed of the disconnect mechanism and the output speed of the disconnect mechanism is below a threshold.

13. A vehicle comprising:
a first electric machine engageable with the ground through a multi-speed transmission; and
a second electric machine engageable with the ground at a fixed speed ratio.

14. The powertrain of claim 13, further comprising:
an engine;
a third electric machine connected to the engine and electrically connected to the first electric machine and the second electric machine.

15. The vehicle of claim 14, further comprising a controller, wherein the controller is configured to command the first electric machine and the second electric machine based on a position of a user input.

16. The vehicle of claim 14, wherein the controller is configured to command at least one of the first electric machine and the second electric machine based on an efficiency of at least one of the first electric machine and the second electric machine.

17. The vehicle of claim 14, wherein the controller is configured to command at least one of the first electric machine and the second electric machine based on a temperature of at least one of the first electric machine, the second electric machine, and the multi-speed transmission.

18. The vehicle of claim 14, wherein the controller is configured to command at least one of the first electric machine and the second electric machine based on a thermal headroom of at least one of the first electric machine, the second electric machine, and the multi-speed transmission.

19. The vehicle of claim 14, further comprising a controller configured to command at least one of the first electric machine and the second electric machine based on an available torque of at least one of the first electric machine and the second electric machine.

20. The vehicle of claim 14, wherein the multi-speed transmission is engageable with the ground through a clutch and the controller is configured to disconnect the clutch when the first electric machine is not exerting torque.
